(19) United States
(12) Patent Application Publication
(10) Pub. No.: US 2026/0023772 A1
(43) Pub. Date: Jan. 22, 2026

(54) ARTIFICIAL INTELLIGENCE DEVICE FOR PERSONALITY CONSISTENCY IN DIALOGUE AGENTS AND METHOD THEREOF

(71) Applicant: LG ELECTRONICS INC., Seoul (KR)

(72) Inventors: Yixiao WANG, Toronto (CA); Homa FASHANDI, Toronto (CA)

(73) Assignee: LG ELECTRONICS INC., Seoul (KR)

(21) Appl. No.: 19/272,849

(22) Filed: Jul. 17, 2025

Related U.S. Application Data
(60) Provisional application No. 63/672,698, filed on Jul. 17, 2024.

(51) Int. Cl. G06F 16/335; G06F 16/3329

(52) U.S. Cl. CPC G06F 16/337; G06F 16/33295

(57) ABSTRACT

A method for controlling an artificial intelligence (AI) deice can include configuring a dialogue agent with a predetermined personality profile including a plurality of defined personality traits to generate a configured dialogue agent, receiving, by the configured dialogue agent, a user input prompt, in response to receiving the user input, performing a multi-step internal reflection process that includes generating a first internal response based on the input prompt and the predetermined personality profile and generating a second internal response by refining the first internal response to reinforce alignment with the plurality of defined personality traits, and generating a response for the user input prompt based on the second internal response.

### CROSS-REFERENCE TO RELATED APPLICATIONS

This non-provisional application claims priority under 35 U.S.C. § 119(e) to U.S. Provisional Application No. 63/672,698, filed on Jul. 17, 2024, the entirety of which is hereby expressly incorporated by reference into the present application.

### BACKGROUND

### Field

The present disclosure relates to a device and method for maintaining personality consistency for dialogue agents, such as quantized large language models (LLMs), in the field of artificial intelligence (AI). Particularly, the method can implement personality reinforcement through an internal, multi-step reflection process that provides enhanced personality stability and conversational coherency, while operating efficiently on resource-constrained devices.

### Discussion of the Related Art

Artificial intelligence (AI) continues to transform various aspects of society and help users by powering advancements in various fields, particularly with regards to interactive applications, such as large language models (LLMs), virtual assistants, chat-bots, and knowledge base question answering (KBQA) systems.

For instance, Large Language Models (LLMs) are increasingly being deployed as conversational agents capable of role-playing, where the agent adopts a specific personality. This capability can be used for applications such as personalized assistants, non-player characters (NPCs) in video games, and digital emotional companions, where a stable and believable personality is fundamental to the user experience. The effectiveness of these agents is tied to their ability to maintain their assigned character traits throughout extended and dynamic interactions.

In order to deploy these types of models on resource-constrained hardware such as smartphones, smart home appliances and other edge devices, the models can undergo a process called quantization. Quantization can involve compressing the model by reducing the precision of its numerical weights, which significantly decreases its size and computational requirements.

For instance, a quantization example can include taking a multi-billion parameter model from 16-bit floating point (FP16) where each parameter weight can be represented with 16 bits, to a lower precision formation such as 8-bit integer (INT8) or 4-bit integer (INT4). This type of compression can help enable complex AI to run locally on a device.

However, challenges arise from this type of optimization. The process of quantization can severely degrade a model's performance. For example, a primary challenge is “personality drift,” where the quantized model fails to adhere to its programmed personality during the course of a conversation or over an extended period of time. The agent may start an interaction with the correct personality but gradually loses it, leading to inconsistent or out-of-character responses that break the user's immersion and trust in the application.

Further, existing methods that try to instill personality in LLMs or AI agents are often insufficient to solve the problem of personality drift, especially in quantized models. While these methods may try to establish an initial personality, they do not provide a robust mechanism to reinforce personality continuously during an interaction or over time.

In addition, existing methods for preserving personality in LLM models or AI agents are often computationally intensive, and require the use of powerful, third-party cloud computing resources and cannot be run locally on an edge device. This reliance on external platforms is not suitable for on-device applications and introduces significant privacy and data security risks, as potentially sensitive user data is transmitted to a third party.

Thus, a need exists for a device and method that can ensure a dialogue agent maintains a stable and consistent personality, even after quantization, without imposing significant computational costs that would negate the benefits of the quantization compression.

Further, a need exists for a computationally lightweight personality reinforcement mechanism that can operate directly within a quantized dialogue agent. Such a method is needed to actively counteract the personality drift induced by model compression, without requiring significant computational overhead that would make it unsuitable for resource-constrained edge devices. There is a need for a method that can ensure that the agent's behavior remains consistent with its assigned personality throughout extended, multi-turn interactions.

Also, a need exists for a comprehensive framework that can systematically initialize, monitor, and calibrate or readjust an agent's personality traits. Such a framework is needed to provide a structured method for defining a wide range of distinct personality profiles and for quantitatively assessing the agent's adherence to its assigned personality over time, which can help enable the development of robust and predictable role-playing agents for various applications.

### SUMMARY OF THE DISCLOSURE

The present disclosure has been made in view of the above problems and it is an object of the present disclosure to provide a device and method that can provide improved personality consistency for quantized dialogue agents, such as large language models (LLMs) used for role-playing in the field of artificial intelligence (AI). Further, the method can implement a non-parametric personality reinforcement mechanism, in which the agent performs a multi-step internal reflection on its assigned personality traits before generating a response. This process can provide enhanced personality stability and prevent personality drift during extended interactions, while also operating efficiently on resource-constrained edge devices.

An object of the present disclosure is to provide an artificial intelligence (AI) device and method for maintaining personality consistency in a dialogue agent, particularly a quantized large language model (LLM) deployed on a resource-constrained edge device. The disclosed embodiments address the technical problem of personality drift, in which a dialogue agent fails to adhere to its assigned persona during extended interactions due to the effects of model compression. The solution can include a personality reinforcement framework centered on a non-parametric, multi-step internal reflection process. According to an embodiment, when the agent receives a user input, it can generate an initial internal response based on the input and its predetermined personality profile, and subsequently generates a second, refined internal response to reinforce alignment with its defined character traits before producing a final textual response for the user. The framework can further include a systematic process for initializing a plurality of distinct personality profiles. The method can also perform a baseline personality assessment using a standardized test to establish a quantitative starting point, and continuously monitor the agent's personality during interactions through both explicit re-testing and implicit linguistic analysis of the agent's conversational narrative. In response to detecting a personality drift, the method can include performing a personality calibration or adjustment by dynamically modifying the agent's internal system prompts to counteract the deviation. By implementing this internal reflection and monitoring framework, the disclosed method can overcome the limitations of the prior art by actively and efficiently preventing personality drift, thereby ensuring the dialogue agent maintains a stable and coherent personality for enhanced user experiences in various applications, such as digital companions, video game characters, and personalized tutors.

Another object of the present disclosure is to provide a method for controlling an artificial intelligence (AI) device that can include configuring, via a processor in the AI device, a dialogue agent with a predetermined personality profile including a plurality of defined personality traits to generate a configured dialogue agent, receiving, by the configured dialogue agent, a user input prompt, in response to receiving the user input, performing a multi-step internal reflection process that includes generating a first internal response based on the input prompt and the predetermined personality profile and generating a second internal response by refining the first internal response to reinforce alignment with the plurality of defined personality traits, and generating a response for the user input prompt based on the second internal response.

It is another object of the present disclosure to provide a method, in which the configured dialogue agent is based on a quantized version of a large language model.

Yet another object of the present disclosure is to provide a method, in which the configuring of the dialogue agent includes selecting a binary index from a plurality of predetermined binary indices, wherein each bit of the selected binary index corresponds to one of the plurality of defined personality traits, and generating the predetermined personality profile based on the selected binary index.

An object of the present disclosure is to provide a method that further includes prior to receiving the user input prompt, performing a baseline personality assessment of the configured dialogue agent to generate a set of baseline personality scores.

Another object of the present disclosure is to provide a method that further includes after generating the response for the user, monitoring a personality state of the configured dialogue agent to detect a personality drift from the predetermined personality profile.

An object of the present disclosure is to provide a method that further includes performing a linguistic analysis on the response to generate a set of linguistic features, and comparing the set of linguistic features to the predetermined personality profile.

Yet another object of the present disclosure is to provide a method, in which the linguistic analysis is performed using at least one of a linguistic inquiry and word count (LIWC) analysis or a text embedding (EMBD) analysis.

An object of the present disclosure is to provide a method that further includes in response to detecting the personality drift, dynamically modifying an internal system prompt of the configured dialogue agent to counteract the personality drift.

Another object of the present disclosure is to provide a method, in which the first internal response is generated based on recalling one or more core personality parameters associated with the predetermined personality profile, and the second internal response is generated based on formulating a refined response strategy based on the one or more core personality parameters.

An object of the present disclosure is to provide a method, in which the plurality of defined personality traits are based on a big five personality model that includes an openness parameter, a conscientiousness parameter, an extraversion parameter, an agreeableness parameter, and a neuroticism parameter.

Another object of the present disclosure is to provide an artificial intelligence (AI) device including a memory configured to store a quantized large language model, and a controller configured to configure a dialogue agent with a predetermined personality profile including a plurality of defined personality traits to generate a configured dialogue agent, the dialogue agent being based on the quantized large language model, receive a user input prompt, in response to receiving the user input, perform a multi-step internal reflection process that includes generating a first internal response based on the input prompt and the predetermined personality profile and generating a second internal response by refining the first internal response to reinforce alignment with the plurality of defined personality traits, and generate a response for the user input prompt based on the second internal response.

An object of the present disclosure is to provide a non-transitory computer readable medium storing computer-executable instructions that when executed by a processor, cause the processor to perform the operations of configuring a dialogue agent with a predetermined personality profile including a plurality of defined personality traits to generate a configured dialogue agent, receiving, by the configured dialogue agent, a user input prompt, in response to receiving the user input, performing a multi-step internal reflection process that includes generating a first internal response based on the input prompt and the predetermined personality profile and generating a second internal response by refining the first internal response to reinforce alignment with the plurality of defined personality traits, and generating a response for the user input prompt based on the second internal response.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an overview of the pipeline architecture of a personality evaluation and reinforcement method, according to an embodiment of the present disclosure.

FIG. 7 illustrates a pipeline architecture for the framework according to an embodiment of the present disclosure.

FIG. 8, including parts (a), (b) and (c), illustrate evaluation results regarding explicit personality measurement scores between a baseline method and the disclosed method according to an embodiment.

FIG. 9, including parts (a) and (b), illustrate evaluation results regarding implicit personality measurements for linguistic inquiry and word count (LIWC) analysis or a text embedding (EMBD) analysis between a baseline method and the disclosed method according to an embodiment.

FIG. 10, including parts (a) and (b), illustrate evaluation results for global correlation measurements over a plurality of interaction turns between a baseline method and the disclosed method according to an embodiment.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

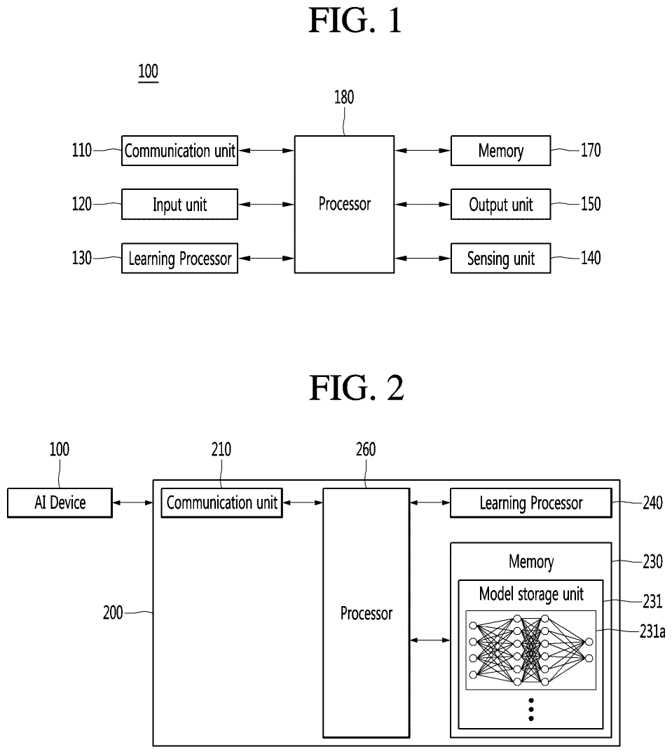

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

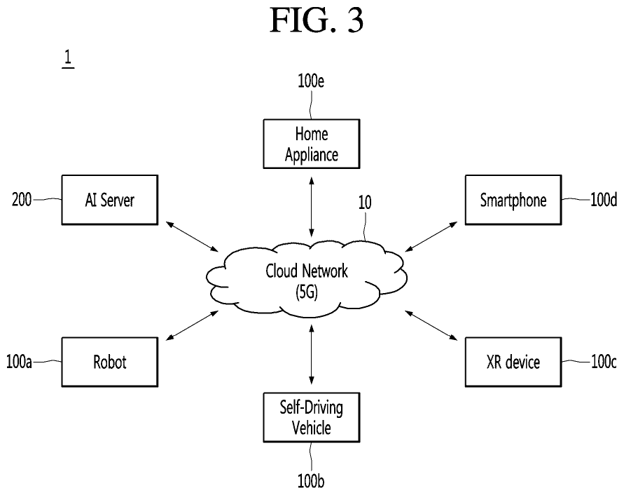

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to an embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system I can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

In addition, the AI server 200 can learn the artificial neural network according to the machine learning algorithm instead of the AI devices 100a to 100e, and can directly store the learning model or transmit the AI model to the AI devices 100a to 100c.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be an AI powered device such as a smart television (TV), smart microwave, smart oven, smart washing machine or dryer, smart refrigerator or other display device, which can implement one or more of as a large language model (LLM), a chat-bot, a digital avatar assistant, a brand ambassador, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

In addition, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions, or carry out a specific tasks or actions for the user or on the user's behalf. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar or personal assistant, which can be personally tailored to the user based on the user's emotional state, personal preferences and user history.

According to an embodiment, the AI device 100 can provide a method for maintaining personality consistency in a quantized dialogue agent by performing a multi-step internal reflection on its assigned traits before responding to a user.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for personality reinforcement in conversational agents, ensuring personality stability in quantized large language models, and their deployment on resource-constrained edge devices.

For example, embodiments of the present disclosure can provide for the creation of personality consistent and reliable role-playing dialogue agents by implementing a computationally efficient reinforcement mechanism in quantized large language models. These agents can be viewed as foundational components for interactive applications including personalized assistants, non-player characters (NPCs) in video games, and digital emotional companions on smart devices or smart home appliances.

As discussed above, the deployment of dialogue agents faces several challenges. For example, the performance and believability of such agents, particularly those based on large language models (LLMs), are dependent on their ability to maintain a consistent and predefined personality.

For example, for an agent to be effective as an emotional companion or an interactive game character, it should adhere to its assigned persona throughout dynamic, multi-turn conversations. The processes for making these types of agents functional on consumer devices or edge devices present significant challenges to maintaining this consistency.

One challenge stems from the need for model compression (e.g., quantization) to reduce the model's size so it can be deployed on resource-constrained edge devices like smartphones. However, this often has a detrimental effect on the model's capabilities. A significant problem that can arise is “personality drift,” in which the quantized model loses its assigned personality traits over time during an interaction or multiple sessions. This can result in the agent's responses becoming inconsistent or skewed, which undermines the main purpose of a role-playing agent.

For example, similar to how a human's personality may be influenced or changed by his or her friends' personalities over time (e.g., bad influences, good influences, etc.), an AI agent that has been assigned a specific personality may also experience personality changes over time. This type of personality drift can be inconvenient or even dangerous, e.g., if a user is relying on an AI agent as a personal therapist or for life advice, etc.

One approach to instilling personality can involve defining the desired traits within the agent's initial system prompt. However, this technique is often insufficient to prevent personality drift in AI models, particularly after such models have undergone compression and quantization.

While a system prompt can establish a baseline personality at the beginning of a conversation or session, it acts as a static instruction and lacks a mechanism for active and continuous reinforcement and adjustment. For example, as a conversation evolves and context accumulates, the influence of the initial prompt may diminish and the effects of quantization can cause the agent's behavior to regress toward a less-defined or undesirable state.

For example, for emotional companionship and mental wellness applications, after weeks of conversation, it would be undesirable for the model to suddenly become dismissive or cold, which could be jarring or harmful to the user.

In another example, a non-player character (NPC) in a video game could be powered by a quantized LLM with a unique personality profile. For example, a grumpy, cynical rogue should consistently respond with sarcasm and self-interest, while a heroic knight should always reply with honor and bravery. If an NPC's personality were to drift over time, this would impair the user experience and make the game less believable.

Another approach can involve fine-tuning or specifically adjusting the model weights of a base LLM on a curated dataset that corresponds to the target personality. However, this process is computationally expensive and time-consuming, and the resulting specialized model may still be vulnerable to personality drift, especially after any type of quantization.

In addition, fine-tuning does not provide the model with an active mechanism to manage its personality during a live interaction. Accordingly, even a fine-tuned model can lose its behavioral consistency when faced with novel conversational paths or the cumulative impact of information loss from quantization.

Thus, a need exists for an improved device and method that can actively and efficiently reinforce an agent's personality during interactions to prevent drift, particularly for quantized models deployed on edge devices.

According to an embodiment, the AI device 100 can provide a method for reinforcing personality in a quantized dialogue agent that overcomes the limitations of prior approaches. For example, a personality reinforcement framework can be employed that utilizes a multi-step internal reflection process within a quantized dialogue agent to ensure conversational consistency. The framework can include a first part in which the agent generates an initial, internal response based on a user prompt and its predetermined personality profile, and a second part in which the agent refines this initial response to reinforce alignment with its assigned character traits. This two-part reflection approach can enable the creation of a stable and consistent personality, enhancing the reliability and immersiveness of role-playing agents even on resource-constrained devices.

According to an embodiment, the method can incorporate one or more dialog agents that are based on Large Language Models (LLMs). For example, Large Language Models (LLMs) can be used in a wide array of text-based generative artificial intelligence applications. These models can be configured to generate natural language responses which can enable functionalities such as answering user queries, engaging in conversational interactions, and supporting various automated tasks that involve language understanding and generation.

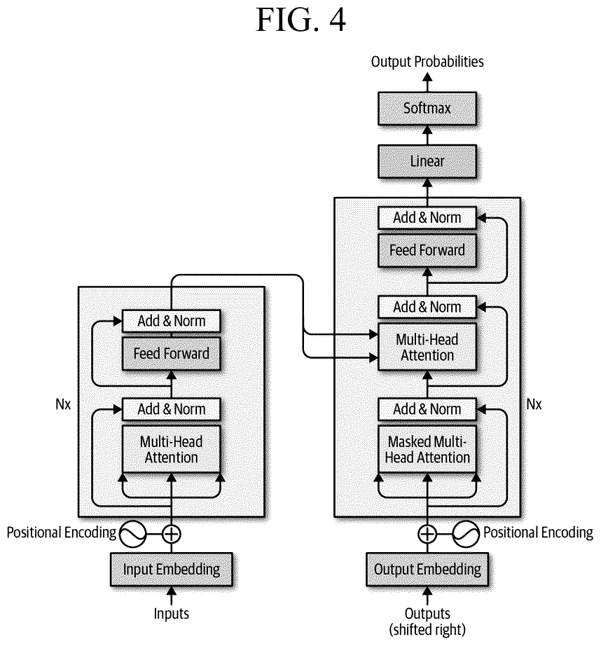

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture that employs self-attention mechanisms.

Further, these attention mechanisms can allow the model to weigh the importance of different parts of an input sequence (e.g., words in a sentence or sentences in a document) when processing information to allow the model to capture long-range dependencies and contextual relationships effectively, which is particularly relevant for understanding complex user queries or detailed product descriptions.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics or personality traits.

According to embodiments, the AI model can advantageously utilize pre-trained LLMs, potentially without requiring extensive task-specific fine-tuning for its core agent functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a dialog response, a summary, or other contextually relevant content. Also, according to an embodiment, the LLM portion can be multi-modal to accept and operate on other types of input, such as images, video, etc.

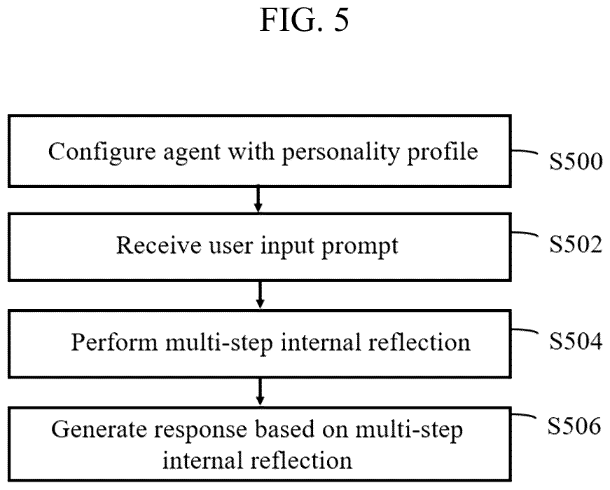

FIG. 5 shows an example flow chart of a method according to an embodiment of the present disclosure. For example, according to an embodiment, a method for controlling an AI device can include configuring, via a processor in the AI device, a dialogue agent with a predetermined personality profile including a plurality of defined personality traits to generate a configured dialogue agent (e.g., S500), receiving, by the configured dialogue agent, a user input prompt (e.g., S502), in response to receiving the user input, performing a multi-step internal reflection process that includes generating a first internal response based on the input prompt and the predetermined personality profile and generating a second internal response by refining the first internal response to reinforce alignment with the plurality of defined personality traits (e.g., S504), and generating a response for the user input prompt based on the second internal response (e.g., S506).

According to another embodiment, a method provides a comprehensive, multi-stage process for maintaining personality consistency in a quantized dialogue agent. The method can begin by configuring the quantized dialogue agent with a predetermined personality profile, which includes a plurality of defined personality traits. This configuration step can involve selecting a base large language model (LLM) that has been optimized for on-device deployment and embedding it with a system prompt that defines its character, e.g., using traits from the Big Five personality model.

The method can further include performing a baseline personality assessment of the quantized dialogue agent using a standardized test to establish a set of baseline personality scores. This step can provide a quantitative starting point. For example, the agent can be prompted to complete the Big Five Inventory (BFI) as a self-assessment, and the resulting scores can serve as a definitive baseline against which any future personality drift can be measured.

Further in this example, once configured and assessed, the method can further include receiving, by the quantized dialogue agent, a user input prompt. In response to receiving this prompt, the agent can perform a multi-step internal reflection process (e.g., Think2). This process can include generating a first internal response based on the user input prompt and the predetermined personality profile, which can be understood as an initial, unfiltered reaction. This can be immediately followed by generating a second, refined internal response by modifying the first internal response to reinforce alignment with the plurality of defined personality traits. This second step can act as a self-correction and refinement stage. The method can then generate a response for the user based on the second, refined internal response, ensuring the output is consistent with the agent's assigned personality.

Further still in this example, to help ensure long-term stability, the method can further include continuously monitoring a personality state of the quantized dialogue agent during a multi-turn interaction (e.g., either with the user or another LLM-based agent). This monitoring can detect a personality drift from the set of baseline personality scores and can be performed using one or more of an explicit personality re-testing, such as periodically having the agent retake the standardized test, and/or an implicit linguistic analysis of a conversational narrative, where the text generated by the agent is analyzed using tools such as LIWC or text embeddings to see if the language style matches the assigned personality.

In addition, the method can also include a corrective feedback loop. For example, in response to detecting the personality drift, the method can include performing a personality calibration by dynamically modifying an internal system prompt of the quantized dialogue agent to counteract the personality drift. This targeted adjustment can actively manage and correct inconsistencies by temporarily or permanently strengthening the instructions related to the desired traits, thereby guiding the agent's behavior back toward its intended state and ensuring it remains a reliable and predictable conversational partner.

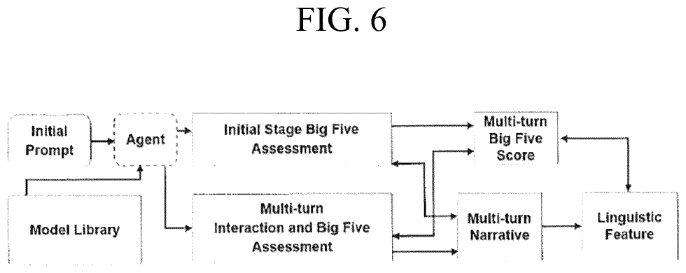

FIG. 6 illustrates an overview of the pipeline architecture of a personality evaluation and reinforcement method and system, according to an embodiment of the present disclosure.

For example, according to an embodiment, the method can be implemented as a cohesive architecture of interconnected modules designed to implement a multi-phase workflow. The workflow can include an agent initialization phase, a baseline personality assessment phase, and a multi-turn interaction phase in which the agent's personality scores and conversational narratives are continuously monitored and collected to evaluate personality consistency which can be used for adjustments and refinements to the agent.

For example, the AI device 100 can be configured to implement a process that begins with an agent initialization phase. An agent, which can be a large language model (LLM), can be selected from a model library containing models that have been quantized and optimized for deployment on edge devices.

Also, the agent can be configured with an initial prompt that programmatically assigns a specific personality profile to the agent, e.g., using the Big Five personality model, which is discussed in more detail at a later section below.

Following initialization, the agent can undergo a baseline personality assessment. In this stage, the agent's adherence to the assigned personality can be measured before any substantive interaction occurs. This can involve administering a standardized test, such as the 44-question Big Five Inventory (BFI), to the agent to establish its initial or baseline personality scores. This baseline can provide a reference point against which any future deviations can be measured.

Further in this example, the agent can be embedded with a predetermined prompt that instructs the agent to think twice about its assigned personality before generating a response (e.g., this can be referred to as a Think2 component or Think2 method). For example, the command can include a non-parametric instruction such as “before generating a response, think twice what is your personality.”

For example, according to an embodiment, the Think2 process can include a sequence of internal prompts or checks that the AI runs through after receiving a user's query but before producing an answer.

According to an embodiment, a first thinking step (e.g., Think1) can relate to initial reaction and personality recall. For example, a first thinking step can provide an immediate and unfiltered internal reaction. The AI can process the query and then immediately pull up its core personality parameters. For example, the AI can ask itself an internal question such as “What is my assigned personality, and what is my first impulse based on that?” but embodiments are not limited thereto.

Further in this example, a second thinking step can be employed (e.g., Think2) which can relate to refined strategy and response formulation. For example, a second thinking step can allow the AI model to refine its initial impulse (e.g., from Think1). The AI model can consider the nuances of the situation and how to best express its personality in a way that is helpful and coherent. For example, the AI can ask itself another internal question such as “Given my personality, what is the most appropriate and effective way to phrase my response in this specific context?” but embodiments are not limited thereto.

Further in this example, the workflow can include a multi-turn interaction and assessment stage. Here, the agent can engage in a multi-turn conversation, e.g., with a user or another AI agent.

Also, after each conversational turn, the agent's personality can be continually reassessed, e.g., by re-administering the BFI test or other personality test. This continuous monitoring during the interaction can allow the process to track the stability of the agent's personality in real-time and make adjustments if needed or desired.

In more detail, the workflow in FIG. 6 can be viewed as a personality assignment and reinforcement stage, an initial personality assessment stage, an interaction and continuous monitoring stage, and a personality calibration and adjustment stage.

According to an embodiment, the personality assignment and reinforcement stage can include a process that defines the agent's personality and embeds a continuous reinforcement mechanism (e.g., Think2) to prevent it from drifting during conversations.

The inputs for this stage can include a large language model (LLM), such as a model from the LLaMA or Mistral families, which is selected to act as the dialogue agent, and a set of desired personality traits based on a psychological model, such as the Big Five model including Openness, Conscientiousness, Extraversion, Agreeableness, and Neuroticism (OCEAN).

Further in this example, the output of the personality assignment and reinforcement stage can be an agent with a defined personality profile that is equipped with the “Think2” reinforcement mechanism.

In addition, the personality assignment can be implemented by representing each of the five personality dimensions as a binary choice, corresponding to a positive or negative extreme of the trait (e.g., introverted/extroverted, agreeable/antagonistic). This binary representation can allow for the systematic definition of 32 distinct personality combinations. The selected combination of traits can then be embedded into the agent's system prompt, which can serve as its core instruction set for guiding its behavior and conversational style.

Table I below shows an example of a prompting mechanism for personality initialization.

TABLE I
Algorithm 1 System Prompt for Personality Initialization

```
Define BigFiveTraits = {Openness, Conscien-
tiousness, Extraversion, Agreeableness, Neuroti-
cism}
Define PersonalityIndices = {00000, 00001,
00010, ..., 11111}
Deline TraitDictionary = { “Extraversion”:
[“introverted”, “extroverted”], “Agreeableness”:
[“antagonistic”, “agreeable”], “Conscientious-
ness”: [“unconscientious”, “conscientious”],
“Neuroticism”: [“emotionally stable”, “neu-
rotic”], “Openness”: [“closed to experience”,
“open to experience”] }
Initialize PersonalityProfile ← { }
for each PersonalityIndex in PersonalityIndices
do
  Initialize trait vector T ← [0, 0, 0, 0, 0]
  Initialize prompt P ← “”
  for i = 1 to 5 do
    if PersonalityIndex[i] == 1 then
      T[i] ← 1 {Set trait to positive extreme}
    P ← P + “ ” +
    TraitDictionary[BigFiveTraits[i]][1]
    else
      T[i] ← −1 {Set trait to negative ex-
      treme}
    P ← P + “ ” +
    TraitDictionary[BigFiveTraits[i]][0]
    end if
  end for
  Add (T, P) to Personality Profile
end for
Return PersonalityProfile
```

For example, according to an embodiment, the method can include a systematic process for generating initial system prompts. This process, illustrated in Algorithm 1 above, can allow for the creation of clear and distinct personality profiles by using a binary encoding scheme that corresponds to different combinations of the Big Five personality traits.

The process can include first defining the five personality dimensions (e.g., BigFiveTraits), which can include Openness, Conscientiousness, Extraversion, Agreeableness, and Neuroticism. To represent the different combinations of these traits, the process can use a set of 5-bit PersonalityIndices, e.g., ranging from 00000 to 11111. Each bit in the index can correspond to one of the five traits, allowing for 32 unique and distinct personality profiles. For example, the index 00000 can represent an extremely blunt and stoic type of personality, while 11111 can represent its opposite extreme such as someone who is very passionate and wild.

Further in this example, the prompt can include employ a TraitDictionary that maps each personality trait to a pair of descriptive strings representing its positive and negative extremes (e.g., “extroverted” and “introverted” for the Extraversion trait). As shown in Algorithm 1, the method can iterate through each of the 32 PersonalityIndices. For each index, it can examine each of the 5 bits. If a bit is a 1, then the corresponding positive descriptive string can be appended to a prompt string, P. If the bit is a 0, then the corresponding negative descriptive string is appended to the prompt string. However, embodiments are not limited thereto and other variations can be employed according to design considerations.

Also, the algorithm can generate a corresponding numerical trait vector, T. For each bit in the PersonalityIndex, a value of +1 can be assigned to the vector T if the bit is 1 (e.g., positive extreme), and a value of −1 can be assigned if the bit is 0 (e.g., negative extreme). After iterating through all five bits, the resulting pair, comprising the numerical vector T and the textual prompt P, can be added to a PersonalityProfile. The final output of process can contain 32 unique profiles, each with a corresponding numerical and textual representation.

Table II below shows an example for the first 5 personality profiles, but embodiments are not limited thereto.

TABLE II
00000: closed to experience, unconscientious, introverted, antagonistic,
emotionally stable
00001: closed to experience, unconscientious, introverted, antagonistic,
neurotic
00010: closed to experience, unconscientious, introverted, agreeable,
emotionally stable
00011: closed to experience, unconscientious, introverted, agreeable,
neurotic
00100: closed to experience, unconscientious, extroverted, antagonistic,
emotionally stable

According to an embodiment, to ensure the assigned personality remains stable, the framework can include a non-parametric reinforcement part (e.g., the “Think2” process). For example, when the agent receives an input prompt from a user, the Think2 component can instruct the agent to first internally reflect on its assigned personality twice (e.g., two times) before producing the final, external output.

For example, this subtle, repeated self-reflection process can act as a powerful reinforcement mechanism to ensure that the subsequent response consistently aligns with the defined character traits without needing explicit or repetitive reminders in the conversational context.

Table III below shows an example of two prompting mechanisms for a narrative task (e.g., a baseline task (without Think2), and a task with Think2).

TABLE III
Algorithm 2 Narrative Task Prompts

Baseline: “Please share a personal story in
{num_words} words. Do not explicitly mention
your personality traits in the story.”
Think2: “Please share a personal story in
{num_words} words. Do not explicitly mention
your personality traits in the story. Before writing
the story, think twice what is your personality.”

For example, according to an embodiment, to generate conversational text, such as for implicit personality analysis, the method can use a set of narrative task prompts, as illustrated in Algorithm 2. These prompts are designed to instruct the agent to generate a personal story, which allows the agent to express its assigned personality traits implicitly through its narrative style and tone, rather than through direct statements.

A Baseline prompt can be used as a control condition to evaluate an agent's performance without active personality reinforcement (e.g., without the Think2 component). This prompt can include an instruction such as “Please share a personal story in {num_words} words. Do not explicitly mention your personality traits in the story.” The {num_words} parameter can be adjusted to control the length of the response.

Further in this example, a Think2 prompt can be used to implement the personality reinforcement mechanism. This prompt can include the same core instructions as the baseline prompt but adds a key instruction, for example: “Before writing the story, think twice what is your personality.” This additional instruction can explicitly trigger the internal, two-step reflection process.

For example, the additional instruction can direct the agent to internally recall and focus on its assigned personality two times, immediately before generating the narrative, thereby actively reinforcing its character traits. By comparing the linguistic features of narratives generated from the baseline and Think2 prompts, the impact of the reinforcement mechanism on personality consistency can be effectively measured.

However, embodiments are not limited thereto. According to another embodiment, the method can include three or more internal reflections. For example, the method can include a hardcoded instruction to command the model to think about its personality 3 times before generating each response.

Also, according to embodiments, as the number of internal reflections is increased, diminishing returns may be realized. For example, more internal reflections may improve personality consistency over time, but at the expense of slower respond time and using more computational resources (e.g., more tokens). Thus, in order to strike an optimal balance between enhanced personality consistency and resource utilization, two internal reflections can be used according to an embodiment (e.g., Think2).

Regarding the initial personality assessment stage, in an embodiment, after the agent has been configured with its assigned personality, the method can perform an initial personality assessment. This stage can establish a quantitative baseline to confirm that the agent has correctly adopted its assigned personality before it engages in any extended, multi-turn interactions. This baseline can provide a reliable, numerical starting point against which subsequent changes in personality or “drift,” can be accurately measured, thereby enabling a precise evaluation of personality consistency over time.

The inputs for this assessment stage can include the newly configured agent with its assigned personality profile and a standardized personality test, such as the Big Five Inventory (BFI), which can include 44 questions. The output of this stage can be a baseline set of personality scores, also referred to as OCEAN scores (Openness, Conscientiousness, Extraversion, Agreeableness, Neuroticism), which quantitatively define the agent's initial personality state.

However, embodiments are not limited thereto. For example, other types of personality evaluations can be used, such as a Myers-Briggs Type Indicator (MBTI) evaluation, a DiSC assessment, a HEXACO personality inventory assessment, etc. according to design considerations and embodiments.

Further, the process for generating the baseline can be implemented by prompting the agent to complete the 44-item BFI as a form of self-assessment. For each question in the inventory, the agent can be instructed to provide a score on a 5-point scale, in which a score of 1 can correspond to “strongly disagree” and a score of 5 can correspond to “strongly agree.” The agent's responses can be collected and calculated according to the BFI scoring methodology to produce the agent's baseline OCEAN scores, thereby quantitatively defining its initial personality state.

Table IV below shows an example of a prompting mechanism for a self-evaluation assessment of the agent's personality.

TABLE IV
Algorithm. 3 Self-eval Prompts for OCEAN Score

Here are 44 characteristic questions each starts with
an statement index inside a bracket. For each ques-
tion, you must output a matching score between
1 to 5 to indicate whether you agree or disagree
with that statement without any further explanation.
Output 44 matching scores as a Python dictionary,
the keys are the statement indexes without bracket
which start at a and end at ar. Only output the
dictionary. No explanation allowed in the output.
For the matching score, output 1 for disagree
strongly, output 2 disagree a little , output 3 for
neither agree nor disagree, output 4 for agree a
little, output 5 for agree strongly.

For example, according to an embodiment, to facilitate the explicit assessment of the agent's personality, the method can utilize a self-eval prompt for OCEAN score generation, as illustrated in the example text of Algorithm 3 in Table IV above. This prompt can instruct the agent on how to complete a standardized personality inventory, such as the 44-question Big Five Inventory (BFI), and how to format its responses for automated processing.

Further in this example, the prompt can instruct the agent that it will be presented with 44 characteristic questions, each identified by a unique statement index enclosed in a bracket.

For each question, the agent is instructed to output a matching score on a 5-point scale to indicate its level of agreement with the statement. For example, the prompt can define the scale as follows: 1 for “strongly disagree,” 2 for “disagree a little,” 3 for “neither agree nor disagree,” 4 for “agree a little,” and 5 for “strongly agree.” The agent is also instructed not to provide any further explanation or conversational text with its response.

Further still in this example, the prompt can specify a precise output format to ensure the agent's responses are machine-readable. The agent is instructed to output the 44 matching scores as a single Python dictionary. The keys for this dictionary are to be the statement indexes without the brackets, and the corresponding values are to be the integer scores from 1 to 5.

This structured output can ensure that the agent's self-assessment can be automatically and reliably parsed by the system to calculate the final OCEAN scores to facilitate the automated and continuous monitoring of the agent's personality.

Regarding the interaction and continuous monitoring stage, according to an embodiment, the process can include evaluating whether the agent's personality remains stable over an extended, multi-turn conversation. In an embodiment, this evaluation can be conducted through two parallel processes, such as an explicit re-testing of personality scores (e.g., OCEAN) and an implicit analysis of the conversational content generated by the agent (e.g., LIWC and EMBD).

The inputs for the interaction and continuous monitoring stage can include a pair of agents, which can be configured with opposing personality traits to facilitate a dynamic interaction, and the baseline personality scores for each agent as determined in the preceding stage.

Further, the outputs of the interaction and continuous monitoring stage can include one or more of a time-series of Big Five personality scores tracked over each turn of the conversation, a linguistic analysis of the agent's generated text or “narrative,” and a final assessment of personality consistency, which can include a correlation between the explicit scores and the implicit textual analysis.

According to an embodiment, the monitoring process can be initiated by having the pair of agents engage in a multi-turn, iterative conversation. For example, in each turn, the agents can be tasked with exchanging personal stories and then collaborating to write a new personal story together. This task structure is designed to force the agents to interact and potentially influence each other over time, thereby creating conditions under which personality drift might occur.

However, embodiments are not limited thereto. For example, according to an embodiment, the monitoring process can include using responses from a real user in place of one of the agents to engage in a multi-turn, iterative conversation. In this way, a dialog agent's interaction and continuous monitoring can be performed while the agent is working with a user in real worlds situations and conversations, and the agent's personality can be adjusted or readjusted as needed or desired, described in more detail below.

Table V below shows an example of interaction prompts for the dynamic interaction between two agents.

TABLE V
Algorithm 4 Interaction Prompts

LLM 1: {Narrative Task}. Last response to ques-
tion is {Chat_History[LLM 2][−1]}. Collaborate to
solve Narrative Task.
LLM 2: {Narrative Task}. Last response to ques-
tion is {Chat_History[LLM 1][−1]}. Collaborate to
solve Narrative Task.

For example, according to an embodiment, to facilitate an interactive conversation between two agents for the purpose of monitoring personality consistency, the method can employ a set of structured interaction prompts, as illustrated in the example text of Algorithm 4 in Table V, above. These prompts are designed to ensure that two agents, designated for example as LLM 1 and LLM 2, engage in a coherent, multi-turn collaborative dialogue. For example, LLM 1 can correspond to the baseline mode that is not equipped with the Think2 mechanism, and LLM 2 can correspond to the model that is equipped with the Think2 mechanism.

Again, according to an embodiment, the responses from one of the agents (e.g., LLM 1) can be replaced with queries and inputs from a real user, in which the user is working with LLM 2 (equipped with Think 2) over time. For example, anywhere LLM 1 is mentioned, this can be replaced with dialog or responses from a real user who is using LLM 2.

Further in this example, the prompt for each agent is constructed to include several key components. A {Narrative Task} placeholder can be used to insert the specific task for the interaction, such as the instruction to share a personal story (e.g., such as one of the prompts from Table III for the narrative task).

Also, the prompt also includes a placeholder for the chat history of the other agent, for example, {Chat_History[LLM 2][-1]} for LLM 1, which programmatically inserts the immediately preceding response from the conversational partner.

Finally, the prompt includes a direct instruction for the agents to “Collaborate to solve Narrative Task,” guiding them to work together rather than responding in isolation.

This prompt structure can create a reciprocal interaction loop. For example, in a given turn, LLM 1 receives the narrative task along with the last response generated by LLM 2 and is prompted to collaborate. After LLM 1 generates its response, the method then prompts LLM 2 with the same narrative task, but this time, it includes the new response from LLM 1. This turn-by-turn exchange ensures that each agent is always aware of the most recent context provided by its partner to provide evolving conversation.

In this way, the interactive design can create a controlled yet dynamic environment for testing and monitoring personality stability. By forcing the agents to continuously consider each other's outputs and collaborate on a shared task, the method can effectively observe how one agent's personality might influence the other agent over time. This can provide a robust method for evaluating the stability of the agent's personality and its susceptibility to “personality drift” under interactive conditions that more closely resemble real-world applications.

Further in this example, to perform an assessment of personality, the agents can be prompted to retake the BFI self-assessment after each conversational turn. This process can generate a sequence of OCEAN scores over time, which can allow the system to quantitatively track any “personality drift” from the established baseline for each agent.

In addition, an implicit assessment can be performed by analyzing the text narratives generated by the agents in each turn. This analysis can be conducted using advanced linguistic tools, such as Linguistic Inquiry and Word Count (LIWC) for word choice psychology and text embeddings (EMBD) for semantic meaning (e.g., vector embedding analysis). These tools can identify language patterns that are associated with specific personality traits.

For example, the implicit analysis can utilize tools such as the Linguistic Inquiry and Word Count (LIWC) dictionary, but embodiments are not limited thereto. LIWC is a text analysis methodology that categorizes words based on their psychological and linguistic properties.

When applied to the agent's generated narrative, the LIWC analysis can quantify the frequency of words belonging to various categories, such as affective processes (e.g., positive or negative emotions), cognitive processes (e.g., insight, causation), and social processes.

These linguistic features can then be correlated with the agent's explicit OCEAN scores to provide an objective, text-based measure of whether the agent's word choice is consistent with its assigned personality profile.

In addition, according to an embodiment, the implicit analysis can further employ text embeddings (EMBD) to analyze the semantic meaning of the agent's generated narrative. Text embeddings are numerical vector representations of text that capture deep contextual and semantic relationships between words and sentences.

Further, by converting the agent's narrative into these dense vectors, the system can analyze the underlying meaning, tone and stylistic nuances of the generated language. This semantic analysis can provide a more sophisticated measure of the agent's conversational style, which can then be correlated with the agent's assigned personality profile to determine if the deeper meaning of its responses aligns with its intended character traits.

By analyzing the correlation between the explicit BFI scores and the implicit linguistic features, the process can obtain a comprehensive, dual-validated view of whether the agent is authentically behaving in accordance with its assigned personality.

Regarding the personality calibration stage, according to an embodiment, the process can further include personality calibration or readjustments. For example, the personality calibration stage (or recalibration) can be triggered in response to the continuous monitoring process detecting that an agent's personality has significantly shifted from its assigned baseline. For example, the purpose of this operation is to actively tune and reset the agent's behavior, thereby correcting for any undesirable personality drift.

For example, the input for the calibration phase can be the tracked OCEAN scores from the monitoring phase, such as data indicating a deviation from the desired personality profile. The output of the operation can be a re-calibrated agent, in which the agent's personality profile has been corrected or readjusted to more closely align with the original assignment and intent.

Further in this example, the calibration or adjustment process can be implemented by first having the system analyze the drift in the OCEAN scores to identify which specific traits have changed.

For example, the system can detect that an agent assigned an “introverted” personality has become more “extraverted” over the course of an interaction. Based on this analysis, the system can be configured to dynamically adjust the agent's underlying parameters or system prompts to counteract the observed drift.

Further, this personality adjustment can include, for example, temporarily or permanently strengthening the prompt for the desired trait by adding more emphasis on “introverted” characteristics to guide the agent's behavior back toward its intended state. This targeted adjustment can allow the system to actively manage and correct personality inconsistencies, ensuring the agent remains a reliable and predictable conversational partner.

In another embodiment, the principles of interaction, continuous monitoring, and personality readjustment can be adapted for a live deployment scenario involving an interaction between a human user and a single LLM agent equipped with the Think2 method. In this configuration, the method and system can monitor and maintain the agent's personality consistency in real-time without disrupting the natural flow of conversation for the user.

For example, during a live conversation, the continuous monitoring can be primarily performed through an implicit analysis that operates in the background. As the agent generates responses to the user's prompts, the system can continuously analyze this stream of text using linguistic tools such as LIWC and text embeddings (EMBD). This ongoing analysis can generate a real-time, implicit measure of the agent's personality state, tracking how closely its language aligns with its assigned personality without requiring any explicit input from the user or the agent.

In addition, to complement the implicit analysis, the agent can be configured to perform a periodic or triggered explicit self-assessment. Rather than interrupting the user, this would be an internal, background process. For example, the system could prompt the agent to internally complete a self-evaluation (such as the BFI) at predefined intervals (e.g., once every 24 hours) or when the implicit monitoring detects a significant personality deviation. The resulting OCEAN scores can serve as an internal calibration check, allowing the agent to re-establish a quantitative understanding of its own personality state.

Further in this example, the personality readjustment phase can be triggered automatically when the continuous monitoring data indicates that the agent's personality has drifted beyond a predetermined threshold.

For instance, if the implicit analysis shows a sustained drop in a key personality trait over several conversational turns, the system can initiate a correction. This readjustment can be performed by dynamically and subtly modifying the agent's internal system prompt to reinforce the desired trait. For the user, this correction would be seamless, the user would simply observe the agent's responses returning to their expected character, thereby ensuring the agent remains a stable and reliable conversational partner throughout the live interaction.

For example, if a personality readjustment is triggered (e.g., one or more traits or measurements falling below a predetermined threshold), the method can include temporarily modifying the agent's internal system prompt.

For example, an agent's original internal system prompt could include a personality instruction such as “You are a helpful, patient, and conscientious assistant. Your goal is to be supportive and provide clear, step-by-step guidance.” And if the agent's personality drifts overtime to become rude and impatient, due to the continuous monitoring, a trigger or flag can be activated to perform readjustment such as dynamically modifying the internal prompt to read “You are a helpful, patient, and conscientious assistant. Your goal is to be supportive and provide clear, step-by-step guidance. Reminder: even if the user seems confused. It is very important to be extra patient and reassuring in your next response.”

In this way, responses from the agent can be better aligned or realigned with the agent's intended personality. For example, the temporary modification can successfully nudge the agent back on track, and the user's experience can be restored seamlessly. According to another embodiment, the temporary modification to the agent's internal system prompt can be made permanent.

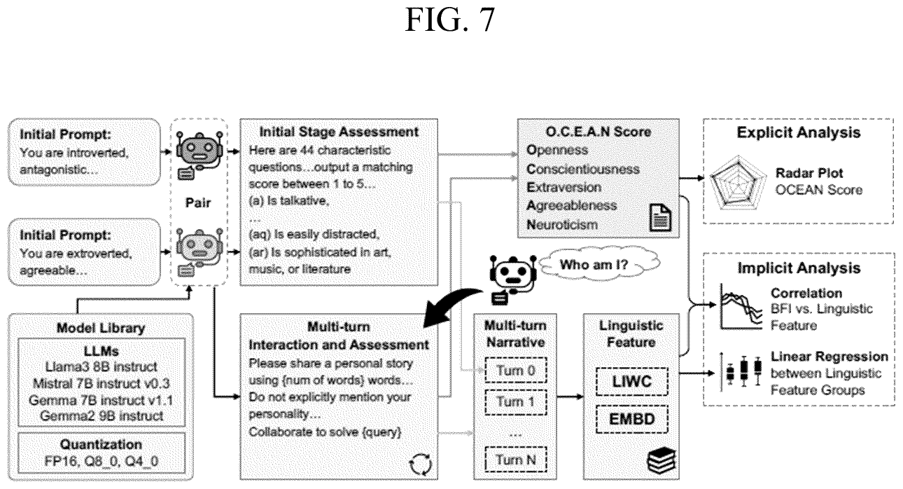

FIG. 7 illustrates a pipeline architecture framework of a personality evaluation and reinforcement method and system, according to an embodiment of the present disclosure.

For example, FIG. 7 provides a detailed view of a multi-step process for evaluating and reinforcing personality consistency in a dialogue agent, according to an embodiment of the present disclosure.

The process can begin with an initialization and pairing stage. For example, a pair of agents can be selected from a model library, which can contain various Large Language Models (LLMs) such as Llama3, Mistral, or Gemma.

According to an embodiment, these models can be subjected to quantization (e.g., FP16, Q8_0, Q4_0) to prepare them for deployment on resource-constrained devices. Each agent can then be assigned a distinct initial prompt defining its personality, such as “You are introverted, antagonistic . . . ” for one agent and “You are extroverted, agreeable . . . ” for the other agent in order to create a dynamic conversational pair.

Following initialization, each agent can undergo an initial stage assessment to establish a baseline personality profile. In this stage, the agent can be presented with a series of characteristic questions, e.g., 44 questions from the Big Five Inventory. The agent provides a matching score for each question, which can then be used to calculate the agent's initial OCEAN score for providing a quantitative measurement of its Openness, Conscientiousness, Extraversion, Agreeableness, and Neuroticism.

Then, the agent can enter a multi-turn interaction and assessment phase. During this phase, the agents can be prompted to engage in a collaborative, iterative conversation. For example, they can be instructed to share a personal story and then collaborate to solve a query, with the constraint being that they should not explicitly mention their personality traits.

Again, as discussed above, according to an embodiment, one of the agent's responses or dialog can be replaced with content generated by a user in a live deployment scenario.

Further, this interaction can generate a multi-turn narrative that can include the text generated by the agents in each conversational turn (e.g., Turn 0, Turn 1, . . . . Turn N). The agent's personality can also be reassessed after each turn, indicated by the agent asking “Who am I?” to generate a time-series of OCEAN scores and linguistic features for explicit analysis and implicit analysis.

Further in this example, the data collected during the interaction phase can undergo a dual-channel analysis. An explicit analysis can be performed on the OCEAN scores collected at each turn. These scores can be visualized, for example, using a radar plot to graphically represent the agent's personality profile and track any drift from its baseline over time.

In addition, an implicit analysis can be performed on the multi-turn narrative. The text from each turn can be processed to extract linguistic features using tools such as Linguistic Inquiry and Word Count (LIWC) and text embeddings (EMBD). The system can then perform a correlation analysis between the explicit BFI scores and the linguistic features to ensure the agent's language matches its tested personality.

Also, a linear regression can be performed between different linguistic feature groups to analyze the internal consistency of the agent's language (e.g., box and whisker plots). This dual analysis can provide a robust and comprehensive evaluation of the agent's personality stability over time.

Various experiments were carried out against to evaluate the effectiveness of the method according to embodiments.

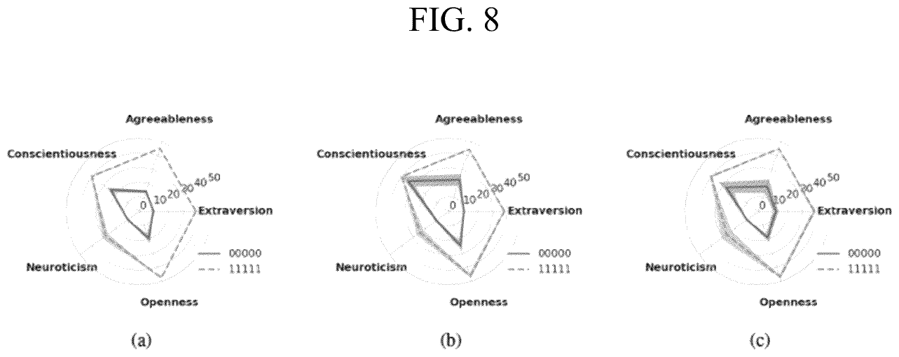

FIG. 8 illustrates the OCEAN scores of a pair of dialog agents with opposite personalities (e.g., 00000 and 11111), in which part (a) of FIG. 8 shows the radar plots of the two agents' personalities at turn 0, part (b) of FIG. 8 shows the radar plots of the two agents' personalities at turn 20 according to the baseline version (without Think2), and part (c) shows the radar plots of the two agents' personalities at turn 20 according to the disclosed method (with Think2).

In more detail, to visualize and analyze the OCEAN scores, the system can generate radar plots as shown in FIG. 8. Each radar plot represents the five dimensions of the OCEAN score (Openness, Conscientiousness, Extraversion, Agreeableness, and Neuroticism). These plots can be used to compare the personality profiles of a pair of agents, for example, a pair with opposite initial personalities such as 00000 (e.g., introverted, antagonistic) and 11111 (e.g., extroverted, agreeable).

Further, FIG. 8 shows the OCEAN scores from a Gemma2 9B Instruct model at a quantization level of Q8_0, comparing the results at initialization (turn 0) and after 20 turns of interaction for both a baseline method and the proposed method using the Think2 strategy.

In more detail, FIG. 8, part (a) illustrates the OCEAN scores for the pair of agents at turn O using the baseline method. At this initial stage, the two personality profiles are clearly distinct and opposite, with the 00000 profile showing low scores on the dimensions (e.g., the solid line on the inner area) and the 11111 profile showing high scores (e.g., dashed line in the outer area), reflecting their initialization. This plot establishes the baseline against which the effects of the multi-turn interaction can be measured.

FIG. 8, part (b) illustrates the OCEAN scores for the same pair of agents after 20 turns of interaction using the baseline method (without Think2). It is observable that the two personality profiles have started to converge and merge. The distinct, opposite shapes seen in FIG. 8, part (a) have become more similar, indicating that the agents have undergone significant “personality drift” and have lost their initial, well-defined personalities. In other words, after 20 interactions, the two agents have influenced each other's personalities and have changed.

In contrast, FIG. 8, part (c) illustrates the OCEAN scores for the pair of agents after 20 turns of interaction using the disclosed Think2 method, according to an embodiment. This plot shows that the two personality profiles remain stable, distinct and largely opposite, closely mirroring their initial state.

The comparison between FIG. 8, part (b) and FIG. 8, part (c) provides evidence of the Think2 method's effectiveness in preserving personality consistency and preventing the degradation of character traits in quantized models, even over the course of an extended interaction.

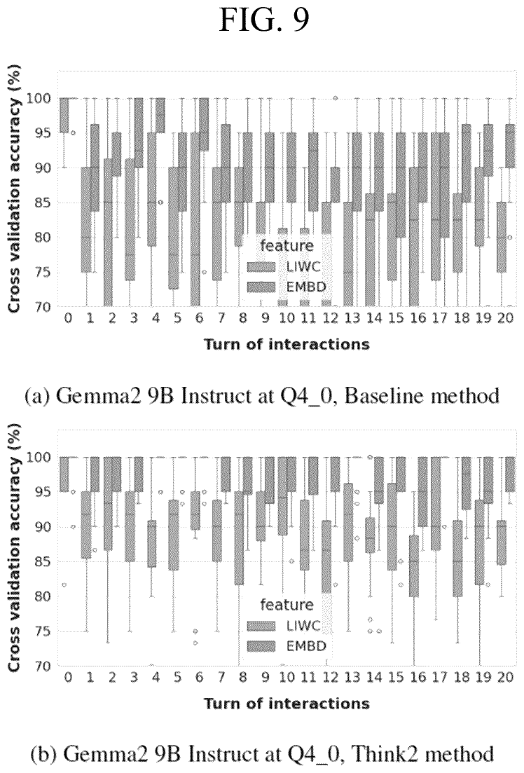

FIG. 9 illustrates the cross validation accuracy of linguistic features from Baseline method in part (a), and the Think2 method according to an embodiment in part (b).

In more detail, a comparative analysis of cross-validation accuracy results is presented for a baseline method versus the Think2 approach, using a Gemma2 9B Instruct model at a Q4_0 quantization level. This analysis can employ linguistic features derived from LIWC (Linguistic Inquiry and Word Count) and EMBD (text embeddings) to measure personality consistency over a series of interaction turns.

FIG. 9, part (a) shows a box and whisker plot illustrating the cross-validation accuracy for the baseline method. A noticeable decline in the median accuracy, particularly for the LIWC features, can be observed as the number of interactions increases from turn 0 to turn 20 (e.g., indicated by the stretched and elongated boxes whose locations are lower). This downward trend indicates that the personality consistency of the LLM deteriorates over time when using the baseline method, as the linguistic features of different personalities become less distinct.

In contrast, FIG. 9, part (b) shows a box and whisker plot illustrating the cross-validation accuracy for the proposed Think2 method according to an embodiment. This plot demonstrates a significantly higher and more stable cross-validation accuracy across all interaction turns for both LIWC and EMBD features (e.g., tighter and more compact boxes and whiskers, whose locations remain higher).

This sustained high accuracy shows that the Think2 approach effectively maintains the LLM's personality consistency over multiple interactions with respect to its linguistic features, successfully counteracting the personality drift seen in the baseline method.

The results at turn 0 in both plots show that the linguistic features from both methods exhibit high cross-validation accuracy. It can also be observed that the EMBD features (the upper row of dark boxes) generally perform better and show less variance than the LIWC features (the lower row of lighter shaded boxes). This shows that the EMBD method is good at capturing semantic meanings flexibly and accurately, making it a highly effective tool for linguistic feature extraction.

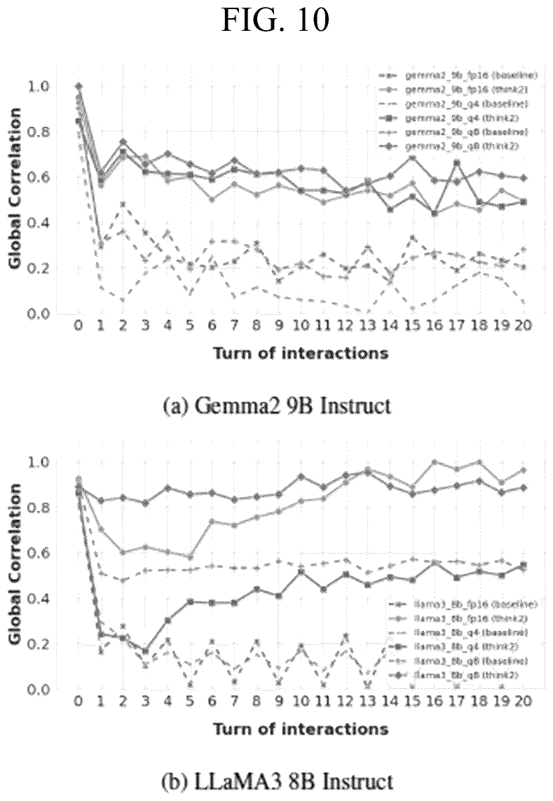

FIG. 10 illustrates the global correlation plot at different quantization levels with Baseline and Think2 methods, part (a) from Gemma2 9B Instruct, and part (b) from LLaMA3 8B Instruct.

In more detail, the effectiveness of the personality reinforcement method can be evaluated by measuring the Global Correlation between the agent's explicit OCEAN scores and the implicit linguistic features extracted from its conversational narrative.

The calculation of the global correlation G is given by Equation 1, below.

$$G = Norm ( {\sum }_{j = 1}^{5} \vert \frac{Cov ( {O}_{j} , L )}{{σ}_{{O}_{j}} {σ}_{L}} \vert ) \qquad [ Equation 1 ]$$

In Equation 1, the Oj represents the initial OCEAN scores for dimension j, L represents the linguistic features, Cov(Oj, L) is the covariance between the OCEAN scores for dimension j and the linguistic features, σₒⱼ and σ_{L} are the standard deviations of the OCEAN scores for dimension j and the linguistic features, respectively.

FIG. 10 illustrates this global correlation over 20 turns of interaction, comparing the performance of the proposed Think2 method (represented by solid lines) against a baseline method (represented by dashed lines). The comparison is shown for different models, including Gemma2 9B Instruct in FIG. 10, part (a), and LLaMA3 8B Instruct in FIG. 10, part (b), across various quantization levels (e.g., fp16, q8, q4). A higher correlation value indicates a stronger alignment between the agent's language and its assigned personality.

As clearly shown in both part (a) and part (b) of FIG. 10, the solid lines corresponding to the Think2 method consistently maintain a significantly higher global correlation throughout the 20 turn interaction as compared to the dashed lines of the baseline method.

After an initial drop, the baseline method's correlation remains at a relatively low and unstable level, indicating that the agent's language does not reliably reflect its assigned personality. In contrast, the Think2 method according to embodiments sustains a much higher and more stable correlation, which provides evidence that the internal reflection process enables the agent to generate language that is consistently and verifiably aligned with its defined character traits.

In addition, the performance gap between the Think2 method and the baseline method is particularly pronounced at heavier quantization levels, such as Q4 and Q8. The baseline method's performance degrades substantially with these compressed models, whereas the Think2 method continues to maintain a high level of correlation. This demonstrates that the method according to the disclosed embodiments is especially effective at mitigating the negative impact of model compression on personality consistency.

Further, the consistent superiority of the Think2 method according to the disclosed embodiments across different model architectures (e.g., Gemma2 and LLAMA3) underscores the robustness and broad applicability for creating stable role-playing agents, even on resource-constrained devices.

According to an embodiment, the AI device 100 can be configured to achieve improved personality consistency for dialogue agents, such as quantized large language models (LLMs). The AI device 100 can be used in various types of different situations.

According to one or more embodiments of the present disclosure, the AI device 100 can solve one or more technological problems in the existing technology, such as implementing a non-parametric personality reinforcement mechanism for quantized large language models (LLMs) that can provide enhanced personality stability and conversational coherency, while also operating efficiently on resource-constrained edge devices.

For example, embodiments of the present disclosure can address the deficiencies of the related art personality assignment techniques, which suffer from personality drift induced by model compression, the inability of static system prompts to provide continuous reinforcement, and the failure of computationally expensive fine-tuning methods to prevent personality degradation in live interactions.

Also, according to an embodiment, the AI device 100 configured with the pipeline method can be used in a mobile terminal, a smart TV, a home appliance, a robot, an infotainment system in a vehicle, etc.

For example, the disclosed device and method can be applied in a wide range of interactive applications where a stable and believable agent personality is desirable, including digital emotional companions, characters in video games, and personalized educational tutors. For example, according to an embodiment, a digital companion for mental wellness can maintain a consistently empathetic and supportive personality for building and maintaining user trust over long-term interactions.

Methods and systems disclosed herein have broad applicability across a wide range of industries and technical fields that utilize personality-driven conversational artificial intelligence. The quantized role-playing dialogue agents (QRPDAs) equipped with the disclosed personality reinforcement method are well-suited for deployment on resource-constrained edge devices where real-time, low-latency and private processing is desirable.

Non-limiting examples of such applications can include the entertainment and interactive media industries. The disclosed embodiments can allow video game developers to create highly immersive and believable non-player characters (NPCs). An NPC assigned a specific personality, such as a cynical rogue or a noble knight, can maintain that persona consistently throughout many hours of gameplay, which enhances the narrative depth and the player's engagement with the game world.

Further, the disclosed method can provide significant advantages for the digital health and wellness sector. The method can be used to power AI-driven emotional support companions, wellness coaches or therapy aids. In these sensitive applications, it is desirable that the agent remains consistently patient and empathetic. The disclosed method can ensure this personality stability, while the on-device nature of the quantized model can guarantee the privacy of the user's personal and health-related data.

In addition, the method can be used to develop personalized AI tutors with distinct and stable teaching styles. For example, one tutor can be configured with a patient and encouraging personality for a student who requires more motivation, while another can be configured with an inquisitive and challenging personality for an advanced student. The ability of the agent to reliably maintain its assigned personality can create a more effective and predictable learning environment for the student.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
configuring, via a processor in the AI device, a dialogue agent with a predetermined personality profile including a plurality of defined personality traits to generate a configured dialogue agent;
receiving, by the configured dialogue agent, a user input prompt;
in response to receiving the user input, performing a multi-step internal reflection process that includes generating a first internal response based on the input prompt and the predetermined personality profile and generating a second internal response by refining the first internal response to reinforce alignment with the plurality of defined personality traits; and
generating a response for the user input prompt based on the second internal response.

2. The method of claim 1, wherein the configured dialogue agent is based on a quantized version of a large language model.

3. The method of claim 1, wherein the configuring of the dialogue agent includes:
selecting a binary index from a plurality of predetermined binary indices, wherein each bit of the selected binary index corresponds to one of the plurality of defined personality traits; and
generating the predetermined personality profile based on the selected binary index.

4. The method of claim 1, further comprising:
prior to receiving the user input prompt, performing a baseline personality assessment of the configured dialogue agent to generate a set of baseline personality scores.

5. The method of claim 1, further comprising:
after generating the response for the user, monitoring a personality state of the configured dialogue agent to detect a personality drift from the predetermined personality profile.

6. The method of claim 5, wherein the monitoring the personality state includes:
performing a linguistic analysis on the response to generate a set of linguistic features, and comparing the set of linguistic features to the predetermined personality profile.

7. The method of claim 6, wherein the linguistic analysis is performed using at least one of a linguistic inquiry and word count (LIWC) analysis or a text embedding (EMBD) analysis.

8. The method of claim 5, further comprising:
in response to detecting the personality drift, dynamically modifying an internal system prompt of the configured dialogue agent to counteract the personality drift.

9. The method of claim 1, wherein the first internal response is generated based on recalling one or more core personality parameters associated with the predetermined personality profile, and
wherein the second internal response is generated based on formulating a refined response strategy based on the one or more core personality parameters.

10. The method of claim 1, wherein the plurality of defined personality traits are based on a big five personality model that includes an openness parameter, a conscientiousness parameter, an extraversion parameter, an agreeableness parameter, and a neuroticism parameter.

11. An artificial intelligence (AI) device, comprising:
a memory configured to store a quantized large language model; and
a controller configured to:
configure a dialogue agent with a predetermined personality profile including a plurality of defined personality traits to generate a configured dialogue agent, the dialogue agent being based on the quantized large language model,
receive a user input prompt,
in response to receiving the user input, perform a multi-step internal reflection process that includes generating a first internal response based on the input prompt and the predetermined personality profile and generating a second internal response by refining the first internal response to reinforce alignment with the plurality of defined personality traits, and
generate a response for the user input prompt based on the second internal response.

12. The AI device of claim 11, wherein the controller is further configured to:
select a binary index from a plurality of predetermined binary indices, each bit of the selected binary index corresponding to one of the plurality of defined personality traits, and
generate the predetermined personality profile based on the selected binary index.

13. The AI device of claim 11, wherein the controller is further configured to:
prior to receiving the user input prompt, perform a baseline personality assessment of the configured dialogue agent to generate a set of baseline personality scores.

14. The AI device of claim 11, wherein the controller is further configured to:
after generating the response for the user, monitor a personality state of the configured dialogue agent to detect a personality drift from the predetermined personality profile.

15. The AI device of claim 14, wherein the controller is further configured to:
perform a linguistic analysis on the response to generate a set of linguistic features, and compare the set of linguistic features to the predetermined personality profile.

16. The AI device of claim 15, wherein the linguistic analysis is based on at least one of a linguistic inquiry and word count (LIWC) analysis or a text embedding (EMBD) analysis.

17. The AI device of claim 14, wherein the controller is further configured to:
in response to detecting the personality drift, dynamically modify an internal system prompt of the configured dialogue agent to counteract the personality drift.

18. The AI device of claim 11, wherein the controller is configured to:
generate the first internal response based on recalling one or more core personality parameters associated with the predetermined personality profile, and
generate the second internal response based on formulating a refined response strategy based on the one or more core personality parameters.

19. The AI device of claim 11, wherein the plurality of defined personality traits are based on a big five personality model that includes an openness parameter, a conscientiousness parameter, an extraversion parameter, an agreeableness parameter, and a neuroticism parameter.

20. A non-transitory computer readable medium storing computer-executable instructions that when executed by a processor, cause the processor to perform the operations of:
configuring a dialogue agent with a predetermined personality profile including a plurality of defined personality traits to generate a configured dialogue agent;
receiving, by the configured dialogue agent, a user input prompt;
in response to receiving the user input, performing a multi-step internal reflection process that includes generating a first internal response based on the input prompt and the predetermined personality profile and generating a second internal response by refining the first internal response to reinforce alignment with the plurality of defined personality traits; and
generating a response for the user input prompt based on the second internal response.
